(19) United States
(12) Patent Application Publication
(10) Pub. No.: US 2005/0286363 A1
(43) Pub. Date: Dec. 29, 2005

(54) Optical recording and/or reproducing apparatus for automatically making copy of optical disc and method thereof

(75) Inventor: In-ho Han, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/165,236

(22) Filed: Jun. 24, 2005

(30) Foreign Application Priority Data
Jun. 24, 2004 (KR) 10-2004-47529

(51) Int. Cl. G11B 5/09

(52) U.S. Cl. 369/47.1; 369/59.1

(57) ABSTRACT

An optical recording and/or reproducing method, and an apparatus to perform the method, the method including reading data from an original optical disc, recording the data on another recording medium, and reading the data on the other recording medium to record the data onto one or more target optical discs, wherein the reading of the data from the original optical disc through the recording of the data onto the one or more target optical discs is automatically performed in response to an optical disc copy mode being chosen.

### CROSS-REFERENCE TO RELATED APPLICATIONS

This application claims the benefit of Korean Patent Application No. 2004-47529, filed on Jun. 24, 2004, in the Korean Intellectual Property Office, the disclosure of which is incorporated herein by reference.

### BACKGROUND OF THE INVENTION

1. Field of the Invention

The present invention relates to an optical recording and/or reproducing apparatus to automatically copy original data recorded on an optical disc onto one or more target optical discs using a recording medium such as a hard disc drive (HDD) of the optical recording and/or reproducing apparatus, and a method of automatically copying the original data onto the one or more target optical discs.

2. Description of the Related Art

Optical recording and/or reproducing apparatuses record a broadcasting signal on, or reproduce a broadcasting signal from, a recording medium. With the development of digitalizing and compressing technology for a broadcasting signal, the function of such an optical recording and/or reproducing apparatus has been expanded.

The optical recording and/or reproducing apparatus supports the use of various video sources, such as a satellite broadcasting signal, cable broadcasting, network broadcasting via the Internet, or the like. Also, with the development of digitalizing and compressing technology for data, the optical recoding and/or reproducing apparatus records data on and/or reproduces data from an optical medium such as a CD-ROM or a digital versatile disc (DVD). Although such an optical medium is used for a long time, the image quality produced from the optical medium typically does not deteriorate. Also, the optical medium can store high quality images and multi-channel (for example, 5.1-channel) audio data. Thus, the optical medium can replace conventional analog image recording media.

An optical medium such as a DVD storing video and audio data can store quantities of data ranging from hundreds of Mbytes to several Gbytes. Recent optical recording and/or reproducing apparatuses have adoptedadopts a large capacity HDD to easily store or read large amounts of data.

A DVD/HDD optical recording and/or reproducing apparatus is a representative example of a combination of a DVD drive and an HDD which both record data and/or reproduce data. In general, the DVD drive reproduces data from an optical disc such as a DVD, an audio CD, a video CD, an MP3 CD, or the like.

Conventionally, a user must provide an original optical disc, such as a DVD, in an optical disc drive to record data of the original optical disc onto a recording medium such as an HDD, and then manually record the data on one or more optical discs again so as to copy the data recorded on the original optical disc.

Thus, when the user copies the data recorded on the original optical disc to one or more optical discs, the user must perform several copying works, which requires a large amount of time.

### SUMMARY OF THE INVENTION

Accordingly, the present general inventive concept solves the above-mentioned and/or other problems, and an aspect of the present general inventive concept is to provide an optical recording and/or reproducing apparatus to automatically copy data recorded on an original optical disc to one or more target optical discs using a recording medium such as an HDD of the optical recording and/or reproducing apparatus, and a method of automatically copying the original data onto the one or more target optical discs.

Additional aspects and/or advantages of the invention will be set forth in part in the description which follows and, in part, will be apparent from the description, or may be learned by practice of the invention.

According to an aspect of the present invention, there is provided an optical recording and/or reproducing method including setting an optical disc copy mode in which data recorded on an original optical disc is automatically recorded on one or more target optical discs; reading the data from the original optical disc, and recording the read data on another recording medium, in response to a request to provide the original optical disc being made and a determination that the original disc has been provided; and reading the data from the other recording medium, and recording the read data on the one or more target optical discs, in response to a request to provide one of the target optical discs and a determination that the one of the target optical discs has been provided.

The optical recording and/or reproducing method may further include deleting the data from the other recording medium in response to the data read from the recording medium being recorded on the one or more target optical discs.

The data read from the other recording medium may be recorded on a predetermined number of the target optical discs in response to a request to input the predetermined number of the target optical discs to which the data is to be copied being made, and the predetermined number being input.

The requests to provide the original optical disc and the one or more target optical discs may be made by displaying corresponding messages.

The other recording medium may be a hard disc drive.

The request to input the predetermined number of the target optical discs to which the data is to be copied may be made by displaying a corresponding message.

The original optical disc and/or the one or more target optical discs may be digital versatile discs or compact discs.

According to another aspect of the present invention, there is provided an optical recording and/or reproducing apparatus including a key input unit to input a command to set an optical disc copy mode in which data recorded on an original optical disc is automatically recorded on one or more target optical discs; an optical disc drive to read the data from the original optical disc and recording the read data on the one or more target optical discs; a recording medium on which the data read from the original optical disc is recorded; and a controller to control the optical disc drive and the recording medium to determine that the original optical disc is provided, read the data from the original optical disc to record the read data on the recording medium, determine that one of the target optical discs is provided, and read the data from the recording medium to record the read data on the one of the target optical discs.

The controller may delete the data from the recording medium in response to the data read from the recording medium being recorded on the target optical disc.

The controller may determine whether the data is recorded on a predetermined number of the target optical discs in response to the data read from the recording medium being recorded on the one of the target optical discs, and may continue to record the data on a remainder of the target optical discs in response to the data not being recorded on the predetermined number of the target optical discs, the predetermined number being input via the key input.

The optical recording and/or reproducing apparatus may further include a display unit, wherein the controller may control the display unit to display a request to provide the original optical disc in response to the optical disc copy mode being set, and to display a request to provide the one of the target optical discs in response to the read data being recorded on the recording medium.

The recording medium may be a hard disc drive.

The optical recording and/or reproducing apparatus may further include a display unit, wherein the controller may control the display unit to display a request to provide the predetermined number of the target optical discs to which the data is to be copied.

The original optical disc and/or the one or more target optical discs may be digital versatile discs or compact discs.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an optical recording and/or reproducing apparatus to automatically make a copy of an optical disc according to an embodiment of the present invention; and

FIG. 2 is a flowchart of an optical recording and/or reproducing method of automatically making a copy of an optical disc according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures. Also, well-known functions or constructions may not be described in detail in order to not obscure the invention in unnecessary detail.

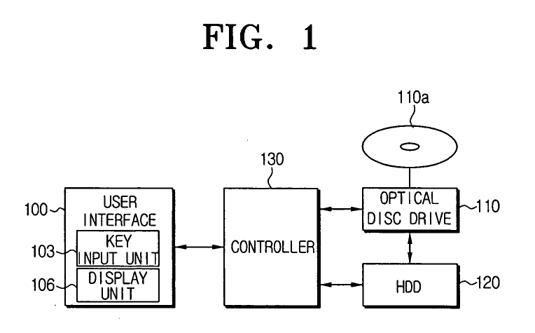

FIG. 1 is a block diagram of an optical recording and/or reproducing apparatus to automatically make a copy of an optical disc according to an embodiment of the present invention. Referring to FIG. 1, the optical recording and/or reproducing apparatus includes a user interface 100, an optical disc drive 110, an HDD 120, and a controller 130.

The optical recording and/or reproducing apparatus reproduces data from an optical disc 110a and records the data provided from the optical disc 110a to a target optical disc and/or the HDD 120. The reproduced data may be provided to a display device before, during, or after the recording of the data onto the target optical disc and/or the HDD 120. For convenience, the optical recording and/or reproducing apparatus will be described based on blocks related to the present invention.

The user interface 100 includes a key input unit 103 and a display unit 106.

A user inputs a manipulation command, a command to set an optical disc copy mode, and a command corresponding to a number of optical discs to which the user desires to copy data to the key input unit 103. Here, the optical disc copy mode indicates a mode in which the optical recording and/or reproducing apparatus automatically copies data on the one or more target optical discs according to the number desired by the user in response to the user providing an original optical disc 110a in the optical disc drive 110 of the optical recording and/or reproducing apparatus.

The display unit 106 displays a request message to provide the original optical disc, for example, “Insert an original optical disc”, a request message to provide a target optical disc, for example, “Insert a target optical disc”, and a message to inquire as to what number of optical discs to which the user desires to copy data, for example, “Input a number of optical discs to which you desire to copy data.”

The optical disc drive 110 records stream form data, such as that generated by a Moving Picture Experts Group (MPEG) encoder (not shown), and/or data read from the HDD 120 on the optical disc 110a, or reads data from the optical disc 110a. Here, the optical disc 110a may be, for example, a DVD or a CD.

The stream form data generated by the MPEG encoder and the data read from the optical disc 110a is recorded on the HDD 120.

When the optical disc copy mode is set via the key input unit 103, the controller 130 controls the display unit 106 to display the message inquiring as to the number of optical discs to which the user desires to copy the data.

When the number of optical discs to which the user desires to copy the data is input via the key input unit 103, the controller 130 controls the display unit 106 to display the request message to provide the original optical disc.

The controller 130 controls the optical disc drive 110 to determine that the original optical disc is provided therein, read data from the original optical disc, and record the read data on the HDD 120.

After the controller 130 records the read data on the HDD 120, the controller 130 controls the display unit 106 to display the request message to provide the target optical disc.

The controller 130 controls the optical disc drive 110 and the HDD 120 to determine that the target optical disc is provided in the optical disc drive 110, read the data from the HDD 120, and record the read data on the target optical disc.

The controller 130 determines whether the data recorded on the original optical disc 110a is recorded on a number of the target optical discs that is equal to the number of optical discs to which the user desires to copy the data, which is the number of optical discs input by the user via the key input unit 103, and controls the optical disc drive 110 to repeatedly record the data on the other target optical discs until the data is recorded on the desired number of the target optical discs.

When the data is completely recorded on the desired number of the target optical discs, the controller 130 may delete the data recorded on the HDD 120.

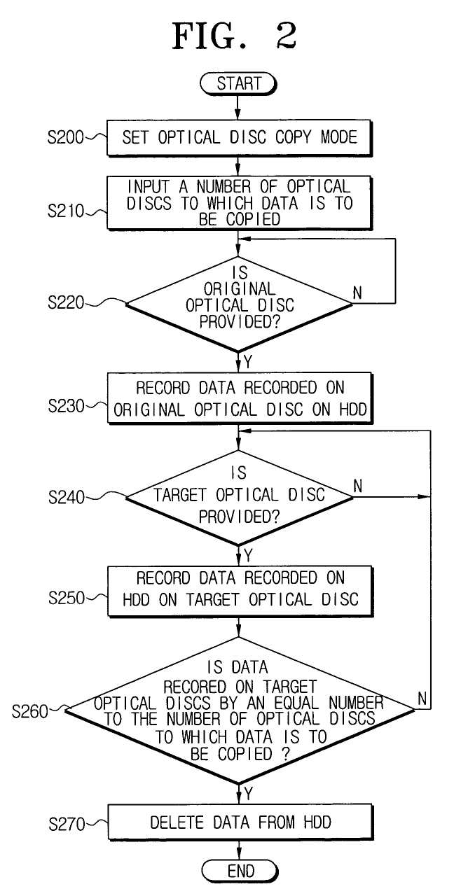

FIG. 2 is a flowchart of an optical recording and/or reproducing method of automatically making a copy of an optical disc according to an embodiment of the present invention. Referring to FIGS. 1 and 2, in operation S200, the user sets the optical disc copy mode using the key input unit 103.

Here, the optical disc copy mode indicates a mode in which, when the user provides an original optical disc in the optical disc drive 110 of the optical recording and/or reproducing apparatus, the optical recording and/or reproducing apparatus automatically copies data on the number of target optical discs desired by the user.

In operation S210, the display unit 106 displays the message inquiring as to the number of optical discs to which the user desires to copy the data, and the user inputs the number of optical discs to which the user desires to copy the data via the key input unit 103.

In operation S220, the display unit 106 displays the message requesting the user to provide the original optical disc 110a, and the controller 103 determines whether the original optical disc 110a is provided in the optical disc drive 110.

If the controller 130 determines in operation in S220 that the original optical disc 110a is mounted in the optical disc drive 110, in operation S230, the optical disc drive 110 reads data from the original optical disc 110a and records the read data on the HDD 120.

In operation S240, the display unit 106 displays the request message to provide the target optical disc, and the controller 130 determines whether the target optical disc is provided in the optical disc drive 110.

If the controller 130 senses in operation S240 that the target optical disc is provided in the optical disc drive 110, in operation S250, the controller 130 reads the data from the HDD 120, and the optical disc drive 110 records the read data on the target optical disc.

In operation S260, the controller 130 determines whether the read data is recorded on the number of the target optical discs that is equal to the number of optical discs to which the user desires to copy the data, which is the number of optical discs input by the user via the key input unit 103.

If the controller 130 determines in operation S260 that the read data is recorded on the number of target optical discs that is equal to the number of optical discs to which the user desires to copy the data, in operation S270, the controller 130 deletes the data recorded on the HDD 120.

If the controller 130 determines in operation S260 that the read data is not recorded on the number of target optical discs that is equal to the number of optical discs to which the user desires to copy the data, the display unit 106 displays the request message to provide another target optical disc, and the controller 130 returns to operation S240 to determine whether the target optical disc is provided in the optical disc drive 110 so as to repeat operation S250 until the read data is recorded on the number of target optical discs that is equal to the number of optical discs desired by the user.

As described above, in an optical recording and/or reproducing apparatus to automatically make a copy of an optical disc, and in a method of automatically making a copy of the optical disc, according to the present invention, data of an original optical disc can be recorded on an HDD, and the data recorded on the HDD can be recorded on one or more target optical discs. Thus, a user does not need to record the data of the original optical disc on the HDD and then manually record the data on the HDD on one or more target optical discs. As a result, the user can save efforts and time.

Although a few embodiments of the present invention have been shown and described, it would be appreciated by those skilled in the art that changes may be made in these embodiments without departing from the principles and spirit of the invention, the scope of which is defined in the claims and their equivalents.

1. An optical recording and/or reproducing method comprising:
setting an optical disc copy mode in which data recorded on an original optical disc is automatically recorded on one or more target optical discs;
reading the data from the original optical disc, and recording the read data on another recording medium, in response to a request to provide the original optical disc being made and a determination that the original disc has been provided; and
reading the data from the other recording medium, and recording the read data on the one or more target optical discs, in response to a request to provide one of the target optical discs and a determination that the one of the target optical discs has been provided.

2. The optical recording and/or reproducing method of claim 1, further comprising deleting the data from the other recording medium in response to the data read from the recording medium being recorded on the one or more target optical discs.

3. The optical recording and/or reproducing method of claim 1, wherein the data read from the other recording medium is recorded on a predetermined number of the target optical discs in response to a request to input the predetermined number of the target optical discs to which the data is to be copied being made, and the predetermined number being input.

4. The optical recording and/or reproducing method of claim 1, wherein the requests to provide the original optical disc and the one or more target optical discs are made by displaying corresponding messages.

5. The optical recording and/or reproducing method of claim 1, wherein the other recording medium is a hard disc drive.

6. The optical recording and/or reproducing method of claim 2, wherein the other recording medium is a hard disc drive.

7. The optical recording and/or reproducing method of claim 3, wherein the other recording medium is a hard disc drive.

8. The optical recording and/or reproducing method of claim 3, wherein the request to input the predetermined number of the target optical discs to which the data is to be copied is made by displaying a corresponding message.

9. The optical recording and/or reproducing method of claim 1, wherein the original optical disc and/or the one or more target optical discs are digital versatile discs or compact discs.

10. The optical recording and/or reproducing method of claim 2, wherein the original optical disc and/or the one or more target optical discs are digital versatile discs or compact discs.

11. The optical recording and/or reproducing method of claim 3, wherein the original optical disc and/or the one or more target optical discs are digital versatile discs or compact discs.

12. The optical recording and/or reproducing method of claim 4, wherein the original optical disc and/or the one or more target optical discs are digital versatile discs or compact discs.

13. An optical recording and/or reproducing apparatus comprising:
a key input unit to input a command to set an optical disc copy mode in which data recorded on an original optical disc is automatically recorded on one or more target optical discs;
an optical disc drive to read the data from the original optical disc and record the read data on the one or more target optical discs;
a recording medium on which the data read from the original optical disc is recorded; and
a controller to control the optical disc drive and the recording medium to determine that the original optical disc is provided, read the data from the original optical disc to record the read data on the recording medium, determine that one of the target optical discs is provided, and read the data from the recording medium to record the read data on the one of the target optical discs.

14. The optical recording and/or reproducing apparatus of claim 13, wherein the controller deletes the data from the recording medium in response to the data read from the recording medium being recorded on the target optical disc.

15. The optical recording and/or reproducing apparatus of claim 13, wherein the controller determines whether the data is recorded on a predetermined number of the target optical discs in response to the data read from the recording medium being recorded on the one of the target optical discs, and continues to record the data on a remainder of the target optical discs in response to the data not being recorded on the predetermined number of the target optical discs, the predetermined number being input via the key input unit.

16. The optical recording and/or reproducing apparatus of claim 13, further comprising:
a display unit;
wherein the controller controls the display unit to display a request to provide the original optical disc in response to the optical disc copy mode being set, and to display a request to provide the one of the target optical discs in response to the read data being recorded on the recording medium.

17. The optical recording and/or reproducing apparatus of claim 13, wherein the recording medium is a hard disc drive.

18. The optical recording and/or reproducing apparatus of claim 14, wherein the recording medium is a hard disc drive.

19. The optical recording and/or reproducing apparatus of claim 15, wherein the recording medium is a hard disc drive.

20. The optical recording and/or reproducing apparatus of claim 16, wherein the recording medium is a hard disc drive.

21. The optical recording and/or reproducing apparatus of claim 15, further comprising:
a display unit;
wherein the controller controls the display unit to display a request to provide the predetermined number of the target optical discs to which the data is to be copied.

22. The optical recording and/or reproducing apparatus of claim 13, wherein the original optical disc and/or the one or more target optical discs are digital versatile discs or compact discs.

23. The optical recording and/or reproducing apparatus of claim 14, wherein the original optical disc and/or the one or more target optical discs are digital versatile discs or compact discs.

24. The optical recording and/or reproducing apparatus of claim 15, wherein the original optical disc and/or the one or more target optical discs are digital versatile discs or compact discs.

25. The optical recording and/or reproducing apparatus of claim 16, wherein the original optical disc and/or the one or more target optical discs are digital versatile discs or compact discs.

26. An optical recording and/or reproducing method comprising:
reading data from an original optical disc;
recording the data on another recording medium; and
reading the data on the other recording medium to record the data onto one or more target optical discs;
wherein the reading of the data from the original optical disc through the recording of the data onto the one or more target optical discs is automatically performed in response to an optical disc copy mode being chosen.

27. The optical recording and/or reproducing method of claim 26, further comprising requesting a user to provide a predetermined number of the target optical discs to which the data is to be recorded.

28. The optical recording and/or reproducing method of claim 26, further comprising requesting a user to provide one of the one or more target optical discs in response to the data being recorded on the other recording medium.

29. An optical recording and/or reproducing method comprising:
reading data from an original optical disc; and
automatically copying the data to one or more target optical discs in response to an optical disc copy mode being chosen.

30. An optical recording and/or reproducing apparatus comprising:
an optical disc drive to read data from an original optical disc and record the data on one or more target optical discs;
a recording medium on which the data read from the original optical disc is recorded; and
a controller to control the optical disc drive to automatically record the data from the recording medium onto one of the one or more target optical discs in response to an optical disc copy mode being chosen.

31. The optical recording and/or reproducing apparatus of claim 30, further comprising a key input unit to input the optical disc copy mode.

32. The optical recording and/or reproducing apparatus of claim 31, wherein a user inputs a predetermined number of the one or more target optical discs onto with the data is to be recorded through the key input unit.

33. The optical recording and/or reproducing apparatus of claim 30, further comprising a display unit to request a user to provide the original optical disc and/or one of the target optical discs.
